(19) United States
(12) Patent Application Publication
(10) Pub. No.: US 2002/0120632 A1
(43) Pub. Date: Aug. 29, 2002

(54) Terrain information server for systems

(75) Inventors: Scott R. Gremmert, Redmond, WA (US); Charles W. Davidson, Newcastle, WA (US); Marc J. Calhoun, Seattle, WA (US); Glen A. Burlingame, Redmond, WA (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc., Morristown, NJ (US)

(21) Appl. No.: 10/085,668

(22) Filed: Feb. 26, 2002

Related U.S. Application Data
(60) Provisional application No. 60/271,979, filed on Feb. 27, 2001.

(51) Int. Cl. G06F 7/00

(52) U.S. Cl. 707/104.1

(57) ABSTRACT

A terrain server provides access to a central database of terrain elevation and other geographical, political, and industrial feature data (terrain data). Systems requiring terrain data, called clients, send requests for such data to the terrain server when such data is needed. The terrain server retrieves, processes, and transmits the terrain data as specified by received requests. Processing necessary to access and format the data as required by the client is performed by the terrain server in accordance with parameters specified in the requests. Specialized formatting, merging of data from different databases, and the combining of dynamic data from other systems is alternatively performed by the terrain server.

### CROSS REFERENCE TO RELATED APPLICATIONS

This application claims the benefit of U.S. Provisional Application Serial No. 60/271,979 filed Feb. 27, 2001, under 35 U.S.C. 119(e).

### FIELD OF THE INVENTION

The present invention relates to terrain data used in systems, and in particular to a terrain data server that provides terrain information to the systems.

### BACKGROUND OF THE INVENTION

Navigation, communication, and surveillance functions implemented on systems function more accurately, safely, or with greater utility if they have access to terrain elevation and geographically related information. Currently most systems requiring such information include its own terrain database and perform all required management and processing functions. Duplicating the terrain database within multiple systems has significant disadvantages including cost of duplicated storage, time for multiple updates, and the possibility of disagreement between different versions.

Terrain information is becoming more detailed, and results in the need for a large database to hold the information. Managing a large database is a complex task that requires significant computing resources. Duplicating these resources across multiple systems results in an overall increase in processing capacity, power usage, space requirements, and weight with a corresponding increase in development, production, operational, and maintenance costs. For systems where terrain data may be beneficial but not required, the extra costs often precludes the inclusion of terrain data with a subsequent decrease in functionality.

Airborne systems that require or could benefit from geographical data include, Enhanced Ground Proximity Warning Systems (EGPWS)/ Terrain Alerting and Warning Systems (TAWS), Flight Management Systems (FMS), Flight Control System (FCS), Weather and Surveillance Radar, Primary Flight Displays, Integrated Navigation Displays, and Traffic Collision and Awareness Systems (TCAS).

### SUMMARY OF THE INVENTION

A terrain server provides access to a central database of terrain elevation and other geographical, political, and industrial feature data (terrain data). Systems requiring terrain data, called clients, send requests for such data to the terrain server when such data is needed. The terrain server retrieves, processes, and transmits the terrain data as specified by received requests. Processing necessary to access and format the data as required by the client is performed by the terrain server in accordance with parameters specified in the requests.

Additional processing, such as specialized formatting, merging of data from different databases, and the combining of dynamic data from other systems is alternatively performed by the Terrain Server.

The terrain server consists of one or more input channels to receive requests, one or more output channels for transmitting requested terrain data, one or more databases, and a processing element to perform data extraction and processing. The terrain server optionally include interfaces and processing elements for loading terrain server databases, for multi-module communications and operations, for receiving related data from other systems, and for maintenance and integrity operations.

In one embodiment, the terrain server function contains or has access to one or more databases containing a combination of terrain elevation, geographic characteristic data, industrial features, navigational information, and/or political features. Each database may contain one or more these feature sets and may contain data for either a specific region, multiple regions, or for the entire globe.

### BRIEF DESCRIPTION OF THE DRAWINGS

FIG. 1 is a block diagram of a terrain server that receives requests from other systems.

FIG. 2 is a flowchart representing operation of the terrain server of FIG. 1.

FIG. 3 is a representation of scaling terrain data in a terrain database with decimation.

FIG. 4 is a representation of scaling terrain data in a terrain database with interpolation.

FIG. 5 is a representation of scaling terrain data in a terrain database with replication.

FIG. 6 is a representation of scaling terrain data in a terrain database using maximum values.

### DETAILED DESCRIPTION OF THE INVENTION

In the following description and the drawings illustrate specific embodiments of the invention sufficiently to enable those skilled in the art to practice it. Other embodiments may incorporate structural, logical, electrical, process, and other changes. Examples merely typify possible variations. Individual components and functions are optional unless explicitly required, and the sequence of operations may vary. Portions and features of some embodiments may be included in or substituted for those of others. The scope of the invention encompasses the full ambit of the claims and all available equivalents. The following description is, therefore, not to be taken in a limited sense, and the scope of the present invention is defined by the appended claims.

The functions described herein are implemented in software in one embodiment, where the software comprises computer executable instructions stored on computer readable media such as memory or other type of storage devices. The term “computer readable media” is also used to represent carrier waves on which the software is transmitted. Further, such functions correspond to modules, which are software, hardware, firmware of any combination thereof. Multiple functions are performed in one or more modules as desired, and the embodiments described are merely examples.

Functions performed in the terrain server of the present invention include receiving data requests from one or more clients for terrain information, managing the requests, and forwarding valid requests to a data extraction function. The data extraction function extracts data from appropriate database(s) as required to fulfill the request. Response data sets are generated using the extracted data, appropriate algorithms, and external data as specified by the request. Each response is formatted and transmitted back to the requester consistent with the request.

Integrity monitoring of the data is performed for process and hardware monitoring and fault reporting as required to ensure integrity of the operation of the terrain server. Multiple server environments are utilized to ensure optimal system operation.

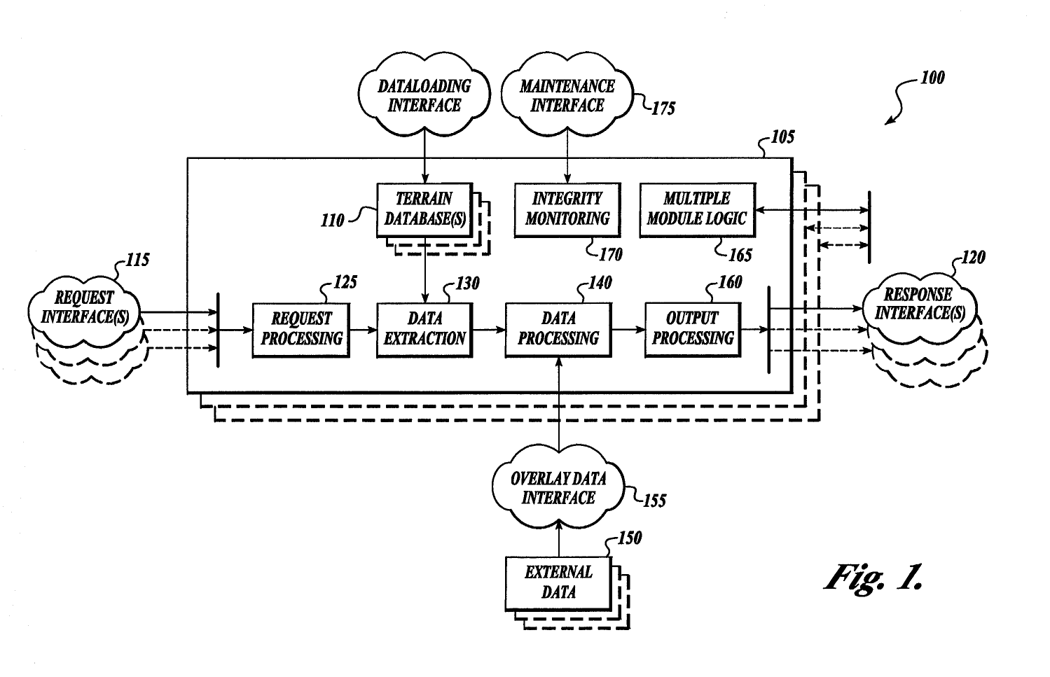

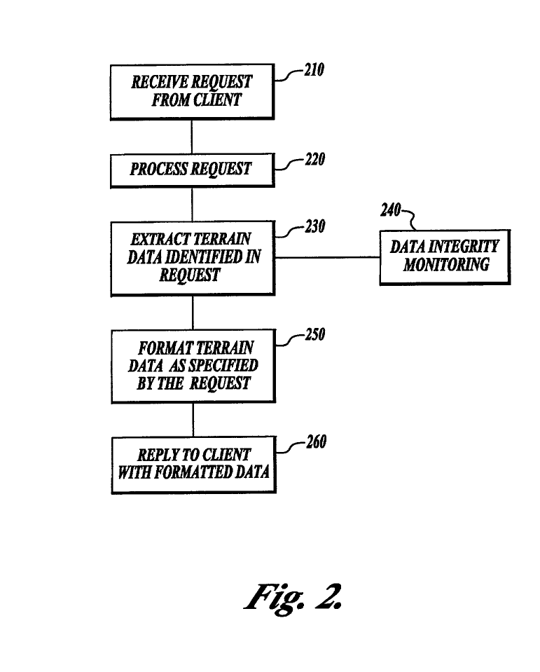

FIG. 1 shows a block diagram of a terrain server generally at 100. Terrain server 100 comprises a terrain system 105 that contains a terrain database 110. Terrain server 100 is a computer system in one embodiment, such as a database server. It is implementable on a personal computer, workstation, server, midrange computer system, embedded computer system or mainframe computer among other systems capable of performing the function via combinations of hardware, firmware and software.

Terrain database 110 structure and content is determined by the type of data required (elevations, obstacles, boundaries, areas, etc.), end user(s) requirements, source data availability, quality, format, and resolution, and physical hardware. In order to support a wide range of scaling and resolution requirements and to optimize system performance, data may be stored in multiple resolutions. For example, terrain elevation data may be stored in 15 arc-sec, 1 arc-min, and 5 arc-min layers. A vectored coastal database may be stored both in a high resolution with data points every 0.1 of mile and low resolution with data points every 10 miles. Terrain data primarily includes elevation information used for airborne situational and navigational awareness. It can also include significant navigational and hazardous items or such as water bodies, urban areas, ice pack, vegetation, oil rigs, bridges, and power lines.

To keep the database to a manageable size high resolution data may only be included for areas of interest such as near airports or airways. Databases are alternatively stored using compression in order to provide maximum coverage while remaining within storage hardware limitations.

Terrain system 105 receives requests from one or more instances or classes of clients via a request interface 115. In one embodiment, the clients comprise aircraft communicating via radio or other wireless technologies. Further clients include other types of airborne systems. Responses to the requests are provided at a response interface 120.

The requests are messages that contain request parameters indicating the location, size, resolution, and type of data required. Each request contains parameters specifying data processing criteria, such as scaling, filtering, orientation, and data layering. Requests may also contain process control criteria including priority indication, response routing information, and integrity requirements. A request processing module 125 parses each received message and then performs integrity and parameter boundary checks.

To support simultaneous or near simultaneous requests from multiple clients, in one embodiment request processing module 125 includes a queuing system to hold and sort pending requests. Request processing module 125 manages all queue functions including the addition of new requests, de-queuing of requests as processing resource become available, and removing aborted requests. Request processing module 125 determines priorities for all requests based on the received order, request type, requested priority, and classification of the requesting device. Request processing module 125 aborts and re-queues requests currently being processed to support the expediting of time critical requests.

Request processing module 125 additionally handles administrative requests including requests for system capability, available data types, resolutions, criticality levels, and other operational specifications; hardware, software, database, or interface versions, part numbers, or compatibility information; system initialization or/and configuration information to enable clients to determine how to generate a request compatible with their individual needs.

A data extraction module 130 locates and extracts data from the appropriate database(s) 110 necessary to meet size and resolution requirements specified by parameters in the request. The data extraction process consists of retrieving the required subset(s) of data from the appropriate database(s), decompressing the selected data, and trimming the extracted data to match the region defined in the request.

The data extraction module first determines the location of requested data and then retrieves from the database(s) data necessary to fulfill the request. If data is stored in a compressed format then the data extraction process decompresses the data. Unless otherwise specified in the request, data requests are filled using data that meets or exceeds the specified resolution whenever such data is available. If data of the desired resolution does not completely cover the requested area then areas of lower resolution are also extracted to allow data processing to fill-in the remaining regions.

The format of the terrain data is typically in the form of a grid of values representing a specific geographic characteristic, such as terrain elevations, terrain feature (water, urban, permafrost, etc) or a set of data points defining a vector (contour line, coastline, political boundary, etc.). Since there may be multiple requests for a particular geographic region (i.e. near the aircraft's current position or intended destination), system performance is improved by caching uncompressed recently or frequently accessed files or data sets.

A data processing module 140 generates a data set satisfying the request from data extracted from the server database(s) 110. Processing by module 140 includes format conversion (vector to grid), combining data sets of different resolutions, scaling to the requested resolution, combining with external data, and performing specialized data processing.

Data format conversion and combining is performed if the format of the source data is different than that requested. Conversion is performed when the requested data format is different from the format of the corresponding database format. For example, a navigation display may request coastline data in grid format while the server database contains this information in vector format. Combining data occurs when data from more than one source is needed to meet the request. For example, high-resolution terrain elevation data may only be available near airports. If the area of the request straddles areas of different source resolutions then the data processing element combines data from the different resolution data sets into a single data set covering the requested area. Data of different types is combined if desired, such as terrain elevation data and obstacles or political boundaries.

Scaling to the requested resolution is the process of adding and/or deleting source data such that the final data set contains the number data points specified in the request. For example, the source data may be scaled at 60 data point cells per degree lat/long while the request may be for a lower resolution of 90 data points per degree. In this case, the response will contain 50% less points than the corresponding source data. The optimal method conversion will vary across client devices and may be specified in the request. Alternative scaling algorithms include:

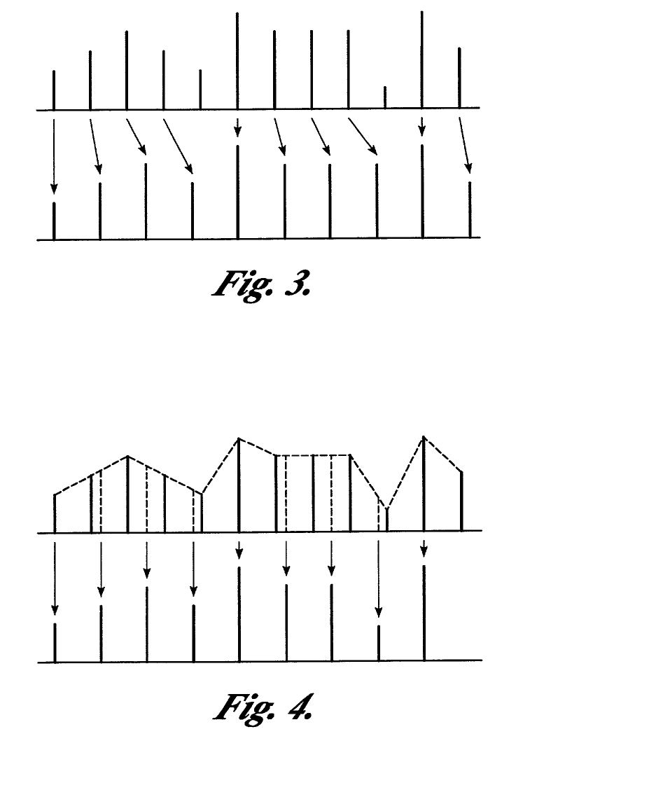

Decimation: When reducing data resolution extra data points are eliminated or decimated as represented in FIG. 3. In this example, every fifth data point is eliminated.

Interpolation: When reducing or increasing data resolution data points not aligned with source data points are interpolated using adjacent points as represented in FIG. 4. Essentially, a line is drawn between points, and the value on the line is used for the value of the new point. The Figures illustrating scaling algorithms represent one dimensional examples for simplicity. Interpolation typically occurs in two dimensions.

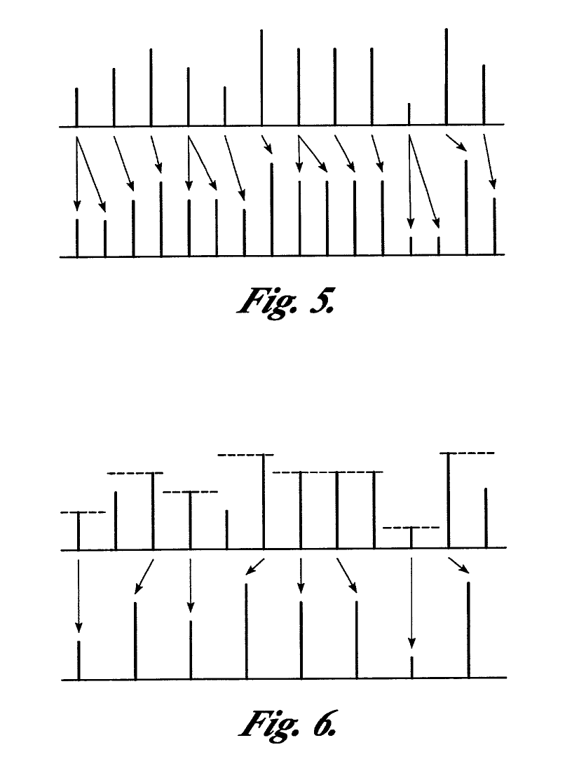

Replication: When increasing resolution data points are copied or replicated to fill in missing points as represented in FIG. 5. In this example, every third data point is replicated.

Average: When decreasing data resolution data points are averaged from eliminated data points.

Maximum: When decreasing data resolution the maximum value of eliminated data points is selected as represented in FIG. 6.

Minimum: When decreasing data resolution the minimum value of eliminated data points is selected in a manner opposite that of FIG. 6.

Data from the Terrain Server databases may be enhanced or modified with data from other processes or systems 150 via an overlay data interface 155. Examples include overlaying threatening terrain from EGPWM/TAWS or Flight path information from the FMS on to terrain elevation data. After receiving data from the external system 150, it is formatted, scaled, and combined in the same manner as described above for data from Terrain Server databases. Data may also be further modified as required for the requesting client. Such processing may include providing terrain elevation information along a specified flight path for a vertical display, filtering to values specified in the request, and rotating to align with the aircraft heading or track.

An output processing module 160 formats and routes the processed data to the requesting client at response interface 120. Output processing module 160 interfaces with one or more physical or logical output connections through which response data is transmitted. Output processing module 160 includes a queue in one embodiment to allow responses for multiple clients to utilize a single output connection. Output processing module 160 handles all queue management functions including priority determination, transmission interruption, and aborted data set deletion.

In order to improve response time, availability, or integrity a system may have more than one Terrain Server. A multiple module logic module 165 determines how requests are to be processed in systems with more than one terrain server system 105. In order to improve system response time request processing can be divided up between available Terrain Servers such that simultaneous requests are processed in parallel. To improve system availability, operational Terrain Servers process responses normally handled by failed components. Integrity is improved by having multiple servers respond to the same request and then comparing the output for discrepancies at an integrity monitoring module 170.

The Terrain Server may provide data that is integral to clients performing critical tasks. It is therefore essential that the Terrain Server ensure that all data provided meet integrity and accuracy requirements. A system integrity logic module 170 continuously monitors the software processes, databases, and hardware to ensure data meets applicable integrity requirements. Monitors may include data integrity checks such a CRC and checksums, hardware watchdogs, task monitoring, memory access, process exception trapping, and variable boundary checking. System monitoring is also performed on all inputs and outputs. Terrain Server and output operational status are continuously provided to the client interface, and/or maintenance interfaces 175.

A downloading interface 180 is provided to download data into terrain databases 110.

1. A method of providing terrain data to multiple users, the method comprising:
receiving a request for terrain data from one of multiple requesters;
extracting requested terrain data from a database of terrain data;
transforming the extracted terrain data to a format identified in the request; and
sending the formatted terrain data to the requestor.

2. The method of claim 1 wherein transforming comprises scaling the extracted terrain data.

3. The method of claim 1 wherein transforming comprises modifying an orientation of the extracted terrain data.

4. The method of claim 1 wherein the request comprises parameters indicating at least one of the location, size, resolution, and type of terrain data required.

5. The method of claim 1 wherein the request comprises process control criteria.

6. The method of claim 5 wherein the process control criteria comprises at least one of a priority indication, response routing information and integrity requirements.

7. The method of claim 1 wherein the request comprises an integrity requirement, and further comprising:
using separate terrain servers to extract terrain data based on a request; and
comparing extracted terrain data from the separate terrain servers.

8. A computer readable medium having instructions for causing a computer to execute a method of providing terrain data to multiple users, the method comprising:
receiving a request for terrain data from one of multiple requesters;
extracting requested terrain data from a database of terrain data;
transforming the extracted terrain data to a format identified in the request; and
sending the formatted terrain data to the requestor.

9. The computer readable medium of claim 8 wherein transforming comprises scaling the extracted terrain data.

10. The computer readable medium of claim 8 wherein transforming comprises modifying an orientation of the extracted terrain data.

11. The computer readable medium of claim 8 wherein the request comprises parameters indicating at least one of the location, size, resolution, and type of terrain data required.

12. The computer readable medium of claim 8 wherein the request comprises an integrity requirement, and wherein the method further comprises:
using separate terrain servers to extract terrain data based on a request; and
comparing extracted terrain data from the separate terrain servers.

13. A system that provides terrain data to multiple users, the system comprising:
means for receiving a request for terrain data from one of multiple requesters;
a data extraction module that extracts requested terrain data from a database of terrain data;
a data processing module that transforms the extracted terrain data to a format identified in the request; and
means for sending the formatted terrain data to the requester.

14. The system of claim 13 and further comprising means for managing queue functions related to the order in which requests are handled.

15. The system of claim 14 wherein queue functions comprise adding new requests, de-queuing of requests, and removing aborted requests.

16. The system of claim 13 and further comprising means for determining the priority of requests based on at least one of received order, request type, requested priority and classification of a requesting device.

17. A system that provides terrain data to multiple users, the system comprising:
a request interface that receives requests for terrain data from multiple requestors;
a data extraction module that extracts requested terrain data from a database of terrain data;
a data processing module that transforms the extracted terrain data to a format identified in the request; and
a response interface that sends the formatted terrain data to the requester.

18. The system of claim 17 wherein the request interface and the response interface comprise a transceiver communicatively coupled to the multiple requestors.

19. A computer readable medium having a terrain data request stored thereon, the request comprising:
a location parameter indicating the location of terrain;
a size parameter indicating the size of terrain about the location of the terrain;
a resolution parameter identifying the resolution of the terrain data corresponding to the location and size parameters; and
a data processing criteria specifying data processing to be performed on the terrain data requested.

20. The computer readable medium of claim 19 wherein the data processing criteria comprises criteria selected from the group consisting of scaling, filtering, orientation and data layering.

21. The computer readable medium of claim 19 wherein the request further comprises process control criteria selected from the group consisting of priority indication, response routing information and integrity requirements.

22. A system that provides terrain data to multiple users, the system comprising:
request interface that receives requests for terrain data from multiple requesters;
a first data extraction module that extracts requested terrain data from a database of terrain data;
a second data extraction module that extracts requested terrain data from a database of terrain data;
a data processing module that transforms the extracted terrain data to a format identified in the request;
a response interface that sends the formatted terrain data to the requestor.

23. The system of claim 22 wherein the data processing module compares extracted terrain data from the first and second extraction modules.

24. The system of claim 22 wherein the data processing module combines extracted terrain data from the first and second extraction modules.

25. The system of claim 22 and further comprising multiple further extraction modules operating in parallel to obtain terrain data from different portions of the terrain identified in the request.

26. A method of providing terrain elevation information to multiple users, the method comprising:
receiving a request for terrain elevation information from one of multiple requestors;
extracting requested terrain elevation information from a database of terrain data;
transforming the extracted terrain elevation information to a format identified in the request as compatible with the requester; and
sending the formatted terrain data to the requestor.
